(19) United States
(12) Patent Application Publication
(10) Pub. No.: US 2024/0152882 A1
(43) Pub. Date: May 9, 2024

(54) INTERCEPTING AND CONTROLLING AN ENTITY INTERACTION

(71) Applicant: Truist Bank, Charlotte, NC (US)

(72) Inventor: Jason Pedone, Raleigh, NC (US)

(73) Assignee: Truist Bank, Charlotte, NC (US)

(21) Appl. No.: 17/983,746

(22) Filed: Nov. 9, 2022

(51) Int. Cl. G06Q 20/06; G06Q 20/40

(52) U.S. Cl. CPC G06Q 20/06; G06Q 20/4015; G06Q 20/405

(57) ABSTRACT

A system can receive, from an entity device associated with a first entity, a threshold value that indicates an entity preference relating to an interaction type. The system can intercept a pending interaction before the pending interaction is executed. The pending interaction can originate from an interaction terminal configured to facilitate transfer of an electronic resource to a second entity. The pending interaction can include an interaction value of the pending interaction, information about the first entity, and information about the second entity. The system can determine whether the interaction value is consistent with the entity preference. The system can provide a result of a comparison between the interaction value and the threshold value. The system can control, based on the comparison between the interaction value and the threshold value, access of the pending interaction to the electronic resource.

### TECHNICAL FIELD

The present disclosure relates generally to electronic interactions and, more particularly (although not necessarily exclusively), to intercepting and controlling interactions based on pre-determined thresholds and interaction history data.

### BACKGROUND

An entity can initiate an interaction with another entity, either at a physical location or on an online platform. The interaction can generate interaction data. The interaction data can be collected, aggregated, classified, and analyzed. Meanwhile, mobile devices and wearable devices with location awareness can connect entities with various services. Different applications can be installed on the mobile devices and wearable devices to facilitate entity interactions. The different applications can be provided by different service providers. A service provider may provide certain services to the entity via a client-side application on an entity device. The service provided can target interactions between the entity and another entity. Providing passive information can be easy for a service provider. However, it can be difficult for the service provider to actively influence the interactions between different entities.

### SUMMARY

In one example, a system can include a processor device and a non-transitory computer-readable memory including instructions that can be executed by the processor device to perform various operations. The system can receive, from an entity device associated with a first entity, a threshold value that indicates an entity preference relating to an interaction type. The system can intercept a pending interaction initiated by the first entity and corresponding to the interaction type before the pending interaction is executed. The pending interaction can originate from an interaction terminal configured to facilitate transfer of an electronic resource to a second entity. The pending interaction can include an interaction value of the pending interaction, information about the first entity, and information about the second entity associated with the pending interaction. The system can determine, by comparing the interaction value to the threshold value, whether the interaction value is consistent with the entity preference. The system can provide, to the entity device, a result of a comparison between the interaction value and the threshold value. The system can control, based on the comparison between the interaction value and the threshold value, access of the pending interaction to the electronic resource.

In another example, a threshold value that indicates an entity preference relating to an interaction type can be received by a computing device and from an entity device associated with a first entity. A pending interaction can be intercepted before being executed. The pending interaction can be initiated by the first entity and may correspond to the interaction type. The pending interaction can originate from an interaction terminal configured to facilitate transfer of an electronic resource to a second entity. The pending interaction can include an interaction value of the pending interaction, information about the first entity, and information about the second entity associated with the pending interaction. The computing device can determine whether the interaction value is consistent with the entity preference by comparing the interaction value to the threshold value. A result of a comparison between the interaction value and the threshold value can be provided to the entity device. Access of the pending interaction to the electronic resource can be controlled based on the comparison.

In a further example, a non-transitory computer-readable medium can include instructions that can be executed by a processor for causing the processor to perform operations. The operations can include receiving, from an entity device associated with a first entity, a threshold value that indicates an entity preference relating to an interaction type. The operations can include intercepting a pending interaction initiated by the first entity and corresponding to the interaction type before the pending interaction is executed. The pending interaction can originate from an interaction terminal configured to facilitate transfer of an electronic resource to a second entity. The pending interaction can include an interaction value of the pending interaction, information about the first entity, and information about the second entity associated with the pending interaction. The operations can include determining, by comparing the interaction value to the threshold value, whether the interaction value is consistent with the entity preference. The operations can include providing, to the entity device, a result of a comparison between the interaction value and the threshold value. The operations can include controlling, based on the comparison between the interaction value and the threshold value, access of the pending interaction to the electronic resource.

### BRIEF DESCRIPTION OF THE DRAWINGS

FIG. 1 is a schematic of a network environment in which an interaction can be controlled using interaction data, geolocation data, and historical interaction data according to one example of the present disclosure.

FIG. 2 is a block diagram of an example of a computing system configured to control interactions using interaction data, geolocation data, and historical data according to one example of the present disclosure.

FIG. 3 is a flowchart of a process for controlling a pending interaction according to one example of the present disclosure.

FIG. 4 is a flowchart of a process for preventing unauthorized initiation of interactions using geolocation data according to one example of the present disclosure.

### DETAILED DESCRIPTION

Certain aspects and features of the present disclosure relate to generating interaction recommendations and controlling interactions based on the interaction recommendations and data such as interaction data, geolocation data, historical data, and the like relating to an entity. An interaction can include an exchange of resources between different entities. The different entities may include a user, an individual, organization, or other suitable entities that can control one or more resources. An interaction recommendation can include a suggestion relating to pending interactions, future interactions, and the like. In some examples, the interaction recommendations can be generated by a trained machine-learning model using interaction data, geolocation data, and historical interaction data. The interaction data include an exchange value and information about the entities relating to the interaction. Geolocation data can include location data from entity devices with location awareness and location information related to certain interactions. Historical interaction data can include exchange values and entity information related to past interactions. Interaction recommendations can be made based on entity-defined parameters and preferences. Interaction recommendations can be provided to a user interface on an entity device such as a wearable device, a mobile device, or the like. The interaction recommendations can be informational, may solicit entity action, or a combination thereof. Interaction recommendations that request an entity action can be in response to intercepting an interaction that can be monitored and paused awaiting entity input on a decision regarding authorizing the interaction. Controlling interactions can involve authorizing a pending interaction or canceling the pending interaction based on entity-defined parameters and preferences, interaction recommendations, entity inputs, or the like.

A system for generating interaction recommendations and controlling interactions for entities can include a coordination engine, an initiation-based recommendation engine, an interaction decisioning engine, a location-based recommendation engine, and a historical-based recommendation engine. Connected entity devices can facilitate generation of various interaction recommendations. The connected entity devices can be smart phones with location awareness. The connected entity devices can also be wearable devices with location awareness, for example, smart watches and smart glasses. An application can be installed to the entity devices to support entity communications with the system, including providing location data, viewing recommendations, and decisioning interactions.

The coordination engine may include application programming interface (API) endpoints and supporting logic that can process and direct all interactions between the user interfaces and supporting sub-components, such as the initiation-based recommendation engine, the interaction decisioning engine, the location-based recommendation engine, and the historical-based recommendation engine, according to the parameters and preferences set by entities. Parameters can be a maximum value for a one-time interaction, for a certain interaction type, or a maximum aggregate value of interactions for a predetermined period. An interaction type can involve exchanges of different categories of resources. Recommendation preferences can include receiving a message if the maximum value for a one-time interaction or a maximum aggregate value of interactions for a predetermined period is to be exceeded with a pending interaction. The recommendation preferences can also include receiving a location-based recommendation message when the entity is proximate to a location. The insight preferences can also include receiving a historical-based recommendation message at certain time with a certain frequency such as at a particular time every day. The parameters and preferences can be updated in the coordination engine.

The coordination engine can handle the communication between an entity device and the initiation-based recommendation engine and the interaction decisioning engine. The interaction decisioning engine can intercept all pending interactions initiated by an entity before the pending interactions are transmitted to an authorization platform for final authorization. An entity can set appropriate parameters and preferences in the coordination engine, the interaction decisioning engine can intercept and hold a pending interaction initiated by the entity before it is executed. The pending interaction is initiated by a first entity to provide electronic resource to a second entity. the pending interaction can include an interaction value. The interaction decisioning engine can re-route data relating to the pending interaction initiated at an interaction terminal to the initiated-based recommendation engine. The initiation-based recommendation engine can generate a control signal to provide or deny access to the electronic resource at the interaction terminal by comparing the interaction value to an interaction preference set by the first entity. The initiation-based recommendation engine can generate and push an initiation-based message, regarding a pending interaction initiated by an entity to the entity device substantially contemporaneous with the initiation of the pending interaction. Historical interaction data may also be used for generating the substantially contemporaneous message. The message may require the entity to decide whether to proceed with the pending interaction via the entity device. The end user's decision may be to authorize or decline the pending interaction. The entity's decision can then be pushed back down from the entity device to the interaction decisioning engine. The pending interaction can be authorized or declined according to the entity's decision.

The initiation-based recommendation engine and interaction decisioning engine can also detect and prevent unauthorized interactions. After the interaction decisioning engine intercepts a pending interaction, the initiation-based recommendation engine can detect the location where the pending interaction is initiated and the location of the entity device. If the two locations match, the message regarding the pending interaction may not include an alert to the entity device. If the two locations do not match, the message may include an alert. The alert can also be a separate message to the entity device for entity verification.

Further, the coordination engine can transmit location data from the entity device in a continuous fashion down to a location-based recommendation engine for generating location-based recommendations. The coordination engine can push the location-based insights to the entity device in response to the location data. The location-based recommendation engine can include API endpoints and supporting logic that can process location data from the entity device in conjunction with map or location data from external sources to generate location-based recommendations based on parameters and preferences set by the entity. When a specific website relating to certain types of interactions is active on the entity device, the location-based recommendation engine can translate the IP address associated with the website to a physical address and collect relevant information related to the physical address, such as the type of interactions it conducts. The location-based recommendation engine can then retrieve relevant interaction history data related to the physical address and the interaction type at the physical address. When an entity is proximate to a certain location, the system can detect the location, extract interaction history data related to the certain location from database and cache the relevant interaction history data for generating location-based recommendations. Once the entity is not proximate to the certain location, the system can automatically clear the cache and release space for interaction history data for generating recommendations related to the next location. The location-based recommendation engine can further lock or deactivate one or more objects associated with the entity temporarily for a certain period or until the entity requests to unlock or deactivate the one or more objects. By taking advantage of location awareness with a mobile or wearable device, the system can push more relevant recommendations regarding the entity's parameters and preferences.

Moreover, the coordination engine can generate and push historical-based recommendations in a batch fashion to the entity device. The historical-based recommendation engine can include API endpoints and supporting logic that can process interaction history data in a batch process to generate pre-staged recommendations according to the entity's parameters and preferences. The historical-based recommendation engine can push insights to the user device in a pre-scheduled batch fashion as specified in the entity's parameters and preferences. The historical-based recommendation engine can also generate a score indicating a likelihood for the entity to exceed a maximum aggregate value of interactions. For example, the score is in a range between 0 and 100. The higher the score is, the less likely the entity is to exceed the maximum aggregate value of interactions set by the entity.

In some examples, the historical-based recommendation engine can train and execute a machine-learning model for making recommendations to end-users in a batch manner. The machine-learning model may include a neural network, such as a deep-learning neural network, a recurrent neural network, and the like, a support vector machine, etc. The historical-based recommendation engine can use interaction history data relating to an end-user and other similar users to train the machine-learning model. For example, the historical-based recommendation engine can access, receive, or retrieve interaction history data for an entity and other entities with similar parameters at regular intervals, such as daily, weekly, bi-weekly, monthly, etc. The historical-based recommendation engine may label the interaction history data or may use an unlabeled version of the interaction history data to train the machine-learning model via supervised training techniques, unsupervised training techniques, semi-supervised training techniques, or any combination thereof. Training the machine-learning model may cause weights between layers of the machine-learning model to be tuned for optimizing predictions or other suitable outputs provided by the machine-learning model. For example, the historical-based recommendation engine can train the machine-learning model and tune the weights of the machine-learning model to cause the machine-learning model to optimize actionable recommendations for a specific entity.

In one example, an end-user can set preferences such as “if I am about to spend over $500 at one interaction, I want to have a second thought about it,” “my monthly spending budget is $2000,” and “I'd like to receive recommendations and insights based on my location and past spending.” When the end-user is proximate to a location, the system can generate an insight message using the end-user's spending comparing to the monthly spending budget. The end-user can make decisions based on the insight message. If historical interactions are already close to or equal to the budget, the system can also deactivate the end-user's credit card for preventing the end-user from exceeding the budget. When the end-user is about to acquire an item costing over $500 at the location, the interaction can be intercepted before it is transmitted to the credit card issuing bank for execution. The system can generate a message to the end-user that “you are spending over $500 for one transaction, are you sure about it?” or it can deactivate the credit card temporarily for preventing the transaction. The system can also generate a daily message to remind the end-user's financial standing with regard to the monthly spending budget, and provide actionable recommendations based on the end-user's interaction history.

These illustrative examples are given to introduce the reader to the general subject matter discussed here and are not intended to limit the scope of the disclosed concepts. In the following description, for the purposes of explanation, specific details are set forth in order to provide a thorough understanding of various implementations and examples. Various implementations may be practiced without these specific details. The figures and description are not intended to be restrictive.

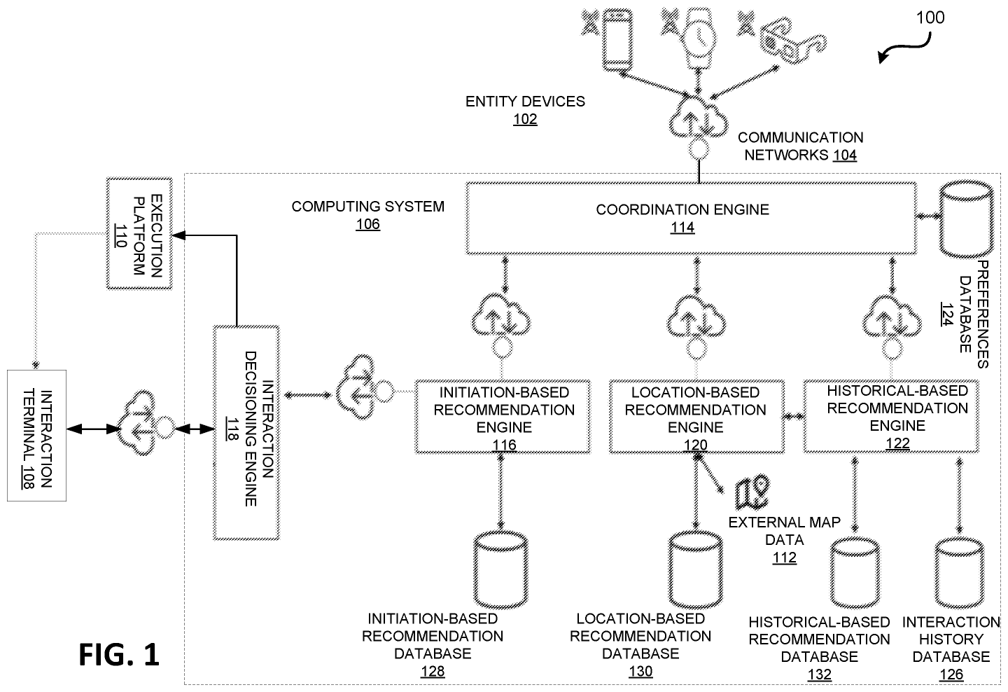

FIG. 1 is a schematic of a network environment 100 in which an interaction can be controlled using interaction data, geolocation data, and historical interaction data according to one example of the present disclosure. The network environment 100 can include entity devices 102, one or more communication networks 104, and a computing system 106. The entity devices 102 are configured with location awareness. The entity devices 102 can transmit location data and input data to and receive recommendation data from the computing system 106 over the one or more communications networks 104. The network environment 100 may correspond to a Wide Area Network (“WAN”) environment, such as the Internet, through which the entity devices 102 may communicate with servers, such as the computing system 106, via web browsers or client-side applications, to establish communication sessions, send and receive web-based information, and access other suitable features of applications or services.

The computing system may be communicatively coupled to one or more external system, such as interaction terminals 108, execution platforms 110, and external map data sources 112. The interaction terminals can be a point of sale (POS) or a virtual payment terminal on an online marketplace platform.

The computing system 106 may be or include any type of server including, for example, a rack server, a tower server, a miniature server, a blade server, a mini rack server, a mobile server, an ultra-dense server, a super server, or the like. The computing system 106 may include various hardware components such as a motherboard, processing units, memory systems, hard drives, network interfaces, power supplies, etc. The computing system may include one or more server farms, clusters, or any other appropriate arrangement or combination of computer servers. Additionally, the computing system 106 may act according to stored instructions located in a memory subsystem of the computing system and may execute an operating system or other applications. In some examples, the computing system may be other types of computer systems other than servers.

The computing system 106 may implement several different applications, services, or modules, and the computing system 106 may perform additional server-side functionality. In one example, the computing system 106 can include a coordination engine 114, an initiation-based recommendation engine 116, an interaction decisioning engine 118, a location-based recommendation engine 120, and a historical-based recommendation engine 122. The coordination engine 114 may be configured to interact with the entity devices 102 for setting parameters and preferences, collecting location data, and delivering recommendation messages from different types of recommendation engines. Parameters and preferences for an entity can be stored in preferences database 124 in the computing system 106. The initiation-based recommendation engine 116 may be configured to create a recommendation message per interaction when the interaction decisioning engine 118 can intercept a pending interaction initiated by an entity at an interaction terminal 108 before the pending interaction is transmitted to an execution platform 110 for execution. The initiation-based recommendation engine can generate a recommendation substantially contemporaneously with the initiation of the pending interaction using data included in the pending interaction, interaction history data stored in an interaction history database 126, and entity parameters and preferences stored in the preferences database 124. The initiation-based recommendation message can be transmitted to an entity device 102 via API endpoints of the coordination engine 114. The entity device 102 may transmit decision data regarding the pending interaction to the initiation-based recommendation engine 116 via API endpoints of the coordination engine 114. The interaction decisioning engine 118 may be configured to decision the pending interaction based on decision data from entity devices 102. The decisioning can be authorizing the pending interaction for execution by an execution platform 110. The decisioning can also be canceling the pending interaction.

The location-based recommendation engine 120 may be configured to generate location-based recommendations using location data from entity devices 102, external map data from external map data sources 112, interaction history data from the interaction history database 126, and entity parameters and preferences stored in the preferences database 124. A location-based recommendation message can be transmitted to the entity device 102 via API endpoints of the coordination engine 114.

The historical-based recommendation engine 122 may be configured to generate recommendations using interaction history data stored in the interaction history database 126 and entity parameters and preferences stored in the preferences database 124. A recommendation message can be transmitted to the entity device 102 via API endpoints of the coordination engine 114.

For example, in implementations of banking or financial services systems, electronic commerce systems, and the like, web-based resources, such as a webpage or any feature or functionality thereof, provided by the computing system 106 may be used by the entity devices 102 to perform various functions, such as receiving insight messages and transmitting decision data based on the insight messages. The entity devices 102, which can include suitable user devices for accessing web-based resources or application-based resources, can be capable of accessing and establishing communication sessions with the computing system 106 and, in some examples, the external systems through the communication networks 104. As illustrated in FIG. 1, entity devices 102 can be mobile devices, including but not limited to tablet computers, smartphones, smart watches, and smart glasses, which may access the computing system 106 via a Local Area Network (LAN) or Wide Area Network (WAN), as well as mobile telecommunication networks, short-range wireless networks, or various other communication network types such as cable networks or satellite networks.

Although certain components are shown in FIG. 1, other suitable, compatible, network hardware components and network architecture designs may be implemented in various embodiments to support communication between the entity devices 102, the computing system 106, and various external systems, such as interaction terminals 108, execution platforms 110, and external map data sources 112. Such communication networks may be any type of network that can support data communications using any of a variety of commercially-available protocols, including, without limitation, TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), Bluetooth®, Near Field Communication (NFC), and the like. Merely by way of example, the network(s) connecting the entity devices 102 and the computing system 106 in FIG. 1 may be local area networks, such as one based on Ethernet, Token-Ring or the like. Such network(s) also may be wide-area networks, such as the Internet, or may include financial or banking networks, telecommunication networks such as a public switched telephone networks (PSTNs), cellular or other wireless networks, satellite networks, television or cable networks, or virtual networks such as an intranet or an extranet. Infrared and wireless networks (e.g., using the Institute of Electrical and Electronics (IEEE) 802.11 protocol suite or other wireless protocols) also may be included in these communication networks.

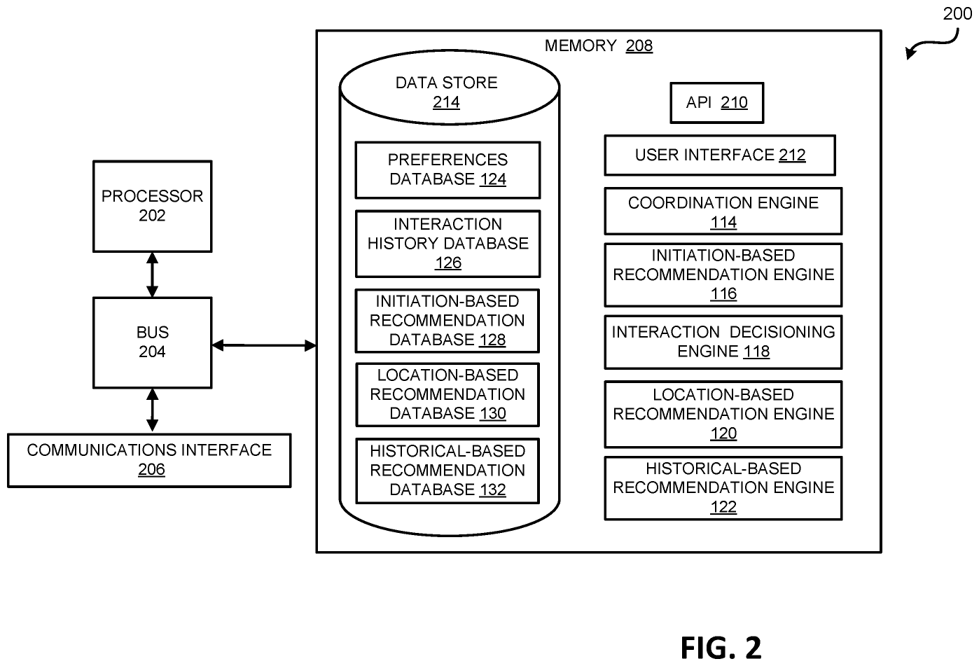

FIG. 2 is a block diagram of an example of a computing system 200 configured to control interactions using interaction data, geolocation data, and historical data according to one example of the present disclosure. The computing system 200 in FIG. 2 can be a detailed configuration of the computing system 106 in FIG. 1. The computing system 200 may be a network device and may include a processor 202, a bus 204, a communications interface 206, a memory 208, and other suitable components. In some examples, the components illustrated in FIG. 2 may be integrated into a single structure. For example, the components can be within a single housing. In other examples, the components illustrated in FIG. 2 can be distributed, for example in separate housings and in electrical communication with each other.

The processor 202 may execute one or more operations for implementing various examples and embodiments described herein. The processor 202 can execute instructions stored in the memory 208 to perform the operations. The processor 202 can include one processing device or multiple processing devices. Non-limiting examples of the processor 202 include a Field-Programmable Gate Array (“FPGA”), an application-specific integrated circuit (“ASIC”), a microprocessor, etc.

The processor 202 may be communicatively coupled to the memory 208 via the bus 204. The memory 208 may include any type of memory device that retains stored information when powered off. Non-limiting examples of the memory 208 include electrically erasable and programmable read-only memory (“EEPROM”), flash memory, or any other type of non-volatile memory. In some examples, at least some of the memory 208 may include a medium from which the processor 202 can read instructions. A computer-readable medium may include electronic, optical, magnetic, or other storage devices capable of providing the processor 202 with computer-readable instructions or other program code. Non-limiting examples of a computer-readable medium include magnetic disk(s), memory chip(s), ROM, random-access memory (“RAM”), an ASIC, a configured processor, optical storage, or any other medium from which a computer processor may read instructions. The instructions may include processor-specific instructions generated by a compiler or an interpreter from code written in any suitable computer-programming language, including, for example, C, C++, C #, Java, Perl, Python, etc.

The communications interface 206 may interface with other network devices or network-capable devices external to the computing system 200. Information received from the communications interface 206 may be sent to the memory 208 via the bus 204. The memory 208 can store any information received from the communications interface 206.

The memory 208 may include program codes for controlling interactions and generating recommendations, and the like. The program codes include APIs 210 configured to make API calls to external systems, such as communicating with entity devices 102, interaction terminals 108, and execution platforms 110 in FIG. 1, and requesting access to external map data sources 112 in FIG. 1.

The program codes may cause the computing system 200, or any suitable component thereof, to generate a user interface 212 configured to provide a user interface to the entity devices 102 for receiving information, such as login credentials or other confidential information and input data, for providing information, such as recommendation messages, etc. In some examples, the user interface 212 may be a customizable user interface that may be presented to an entity on an entity device 102.

The memory 208 may also include program codes for a coordination engine 114, an initiation-based recommendation engine 116, an interaction decisioning engine 118, a location-based recommendation engine 120, and a historical-based recommendation engine 122. The memory 208 may additionally include program codes for a data store module 214. The data store module 214 may include a preferences database 124, an interaction history database 126, an initiation-based recommendation database 128, a location-based recommendation database 130, a historical-based recommendation database 132. In some examples, the computing system 200 accesses to an external interaction history database, and the interaction history database 126 may temporarily store retrieved interaction history data needed for controlling pending interactions and generating recommendations. Besides, the data store module 214 may store information relating to one or more entity objects for associated entities and entity devices, including but not limited to username, password, security information, and entity identification.

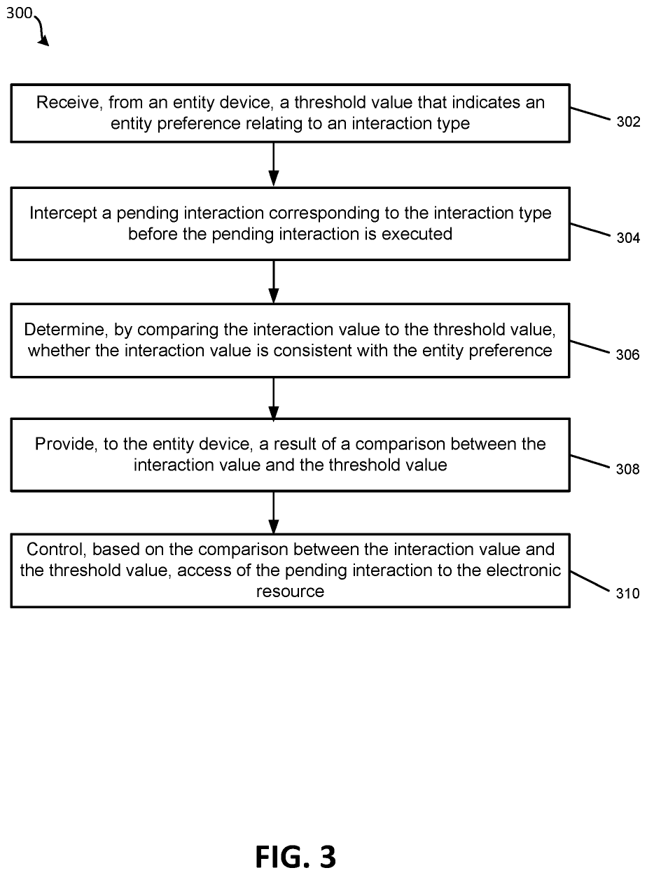

FIG. 3 is a flowchart of a process 300 for controlling a pending interaction according to one example of the present disclosure. At block 302, the computing system 106 receives from an entity device 102, a threshold value that indicates an entity preference relating to an interaction type. The threshold value can be a maximum value for the interaction type. The threshold value can also be a maximum aggregate value of interactions for a predetermined period. An entity can set up its parameters and preferences in the computing system 106 via a user interface 212 on a client-side application installed on the entity device 102. The threshold value is from the parameters and preferences set by the entity.

At block 304, the computing system 106 intercepts a pending interaction corresponding to the interaction type over a communication network 104 before the pending interaction is executed. The pending interaction can be initiated by a first entity at an interaction terminal relating to providing an electronic resource to a second entity. The pending interaction can include an interaction value of the pending interaction, information about the first entity initiating the pending interaction, and information about the second entity with which the first entity initiates the pending interaction. The first entity is associated with the entity device. In some examples, when the first entity initiates an interaction with the second entity at an interaction terminal 108, the client-side application on an entity device 102 for the first entity can detect the pending interaction. The interaction decisioning engine 118 can intercept the pending interaction at the interaction terminal before it is transmitted to an execution platform 110 for execution.

At block 306, the computing system 106 determines whether the interaction value is consistent with the entity preference, by comparing the interaction value to the threshold value. The initiation-based recommendation engine 116 can compare the interaction value to the threshold value. The threshold value indicates an entity preference. In some examples, the threshold value is a maximum value for the interaction type. When the interaction value does not exceed the maximum value for the interaction type, the pending interaction can be considered as being consistent with the entity preference. When the interaction value exceeds the maximum value for the interaction type, the pending interaction can be considered as not being consistent with the entity preference. In some examples, the threshold value is a maximum aggregate value of interactions for a predetermined period. The initiation-based recommendation engine 116 can also retrieve or receive interaction history data for the predetermined period from the interaction history database 126, and then compare the interaction value together with the interaction history data for the predetermined period to the threshold value. When the interaction value and the interaction history data for the predetermined period does not exceed the maximum aggregate value of interactions for the predetermined period, the pending interaction can be considered as being consistent with the entity preference. When the interaction value and the interaction history data for the predetermined period exceeds the maximum aggregate value of interactions for the predetermined period, the pending interaction can be considered as not being consistent with the entity preference.

At block 308, the computing system 106 provides, to the entity device 102, a result of a comparison between the interaction value and the threshold value. The result of the comparison can be transmitted by the initiation-based recommendation engine 116 in a format of a recommendation message via the coordination engine 114 to the entity device 102. The recommendation message can also request an input from the initiating entity via the entity device 102 regarding the pending interaction. The input can be to proceed with the pending interaction or cancel the pending interaction.

At block 310, the computing system 106 generates, based on the comparison between the interaction value and the threshold value, a control signal to provide access to the electronic resource at the interaction terminal when the interaction value is consistent with the entity preference and to deny access to the electronic resource at the interaction terminal when the interaction value is not consistent with the entity preference. When the threshold value is a maximum value for the interaction type, the initiation-based recommendation engine 116 can determine whether the interaction value exceeds the maximum value for the interaction type. If the interaction value exceeds the maximum value for the interaction type, the initiation-based recommendation engine 116 can generate a recommendation message of disapproving the pending interaction to the initiating entity via the entity device 102 and to the interaction decisioning engine 118. The interaction decisioning engine 118 can prevent the pending interaction from being executed based on the recommendation message. In some examples, the pending interaction can be canceled. If the interaction value does not exceed the maximum value for the interaction type, the initiation-based recommendation engine 116 can generate a recommendation message of approving the pending interaction to the initiating entity via the entity device 102 and to the interaction decisioning engine 118. The interaction decisioning engine 118 can authorize and release the pending interaction to the execution platform 110 for execution.

In some examples, the threshold value is a maximum aggregate value of interactions for a predetermined period. The initiation-based recommendation engine 116 can receive interaction history data for the predetermined period from the interaction history database 126. The initiation-based recommendation engine 116 can then compare the interaction value for the pending interaction together with the interaction history data for the predetermined period to the maximum aggregate value of interactions. If the interaction value for the pending interaction together with the interaction history data for the predetermined period exceeds the maximum aggregate value of interactions, initiation-based recommendation engine 116 can generate a recommendation message of disproving the pending interaction to the initiating entity via the entity device 102 and to the interaction decisioning engine 118. The interaction decisioning engine 118 can then prevent the pending interaction from being executed. In some examples, the pending interaction can be canceled. If the interaction value for the pending interaction together with the interaction history data for the predetermined period does not exceed the maximum aggregate value of interactions, the initiation-based recommendation engine 116 can generate a recommendation message of approving the pending interaction to the initiating entity via the entity device 102 and to the interaction decisioning engine 118. The interaction decisioning engine 118 can then authorize and release the pending interaction to an execution platform 110 for execution.

In some examples, the computing system 106 can receive an input from the initiating entity by the entity device 102, upon receiving a recommendation message regarding the pending interaction. The input can be an updated entity preference for the pending interaction. If the input indicates that the pending interaction should proceed, the interaction decisioning engine 118 can authorize and release the pending interaction to an execution platform 110 for execution. If the input indicates that the pending interaction should be declined, the interaction decisioning engine 118 can cancel the pending interaction. The interaction decision engine can act on the pending interaction substantially contemporaneous with the input received from the initiating entity.

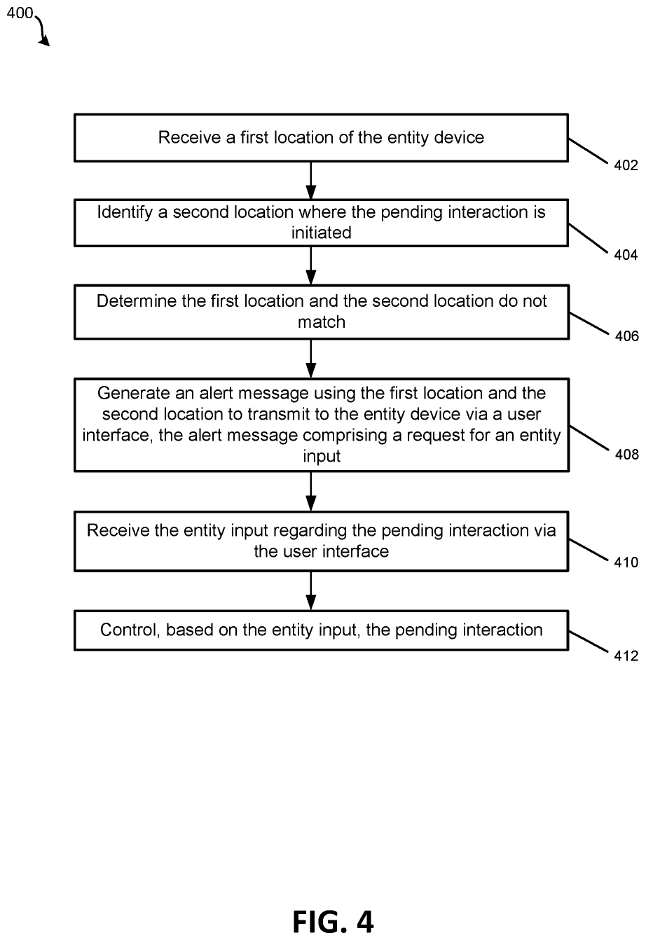

FIG. 4 is a flowchart of a process for preventing unauthorized initiation of interactions using geolocation data according to one example of the present disclosure. At block 402, the computing system 106 receives a first location of the entity device 102. The entity device 102 is configured with location awareness and can transmit location data to the computing system 106 via a client-side application installed on the entity device 102.

At block 404, the computing system 106 identifies a second location where the pending interaction is initiated. When the second entity is a physical location where the pending interaction is initiated, the location data of the second entity can be identified in data accompanying the pending interaction. When the second entity is a website where the pending interaction is initiated, the initiation-based recommendation engine 116 can identify the IP address visiting the website and translate the IP address into a physical address. The initiation-based recommendation engine 116 can then identify the physical address as the second location where the pending interaction is initiated.

At block 406, the computing system 106 determines the first location and the second location do not match. The location of the entity device can represent the location of the first entity who can initiate the pending interaction. When the location of the entity device and the location where the pending interaction is initiated do not match, it may be that the pending interaction is initiated by another entity approved by the first entity, it may be that the pending interaction is initiated by another entity not approved by the first entity.

At block 408, the computing system 106 generates an alert message using the first location and the second location to transmit to the entity device via a user interface, the alert message including a request for an entity input. The initiation-based recommendation engine 116 can generate the alert message to transmit to the first entity via the user interface on the entity device 102, requesting an entity input regarding the pending interaction.

At block 410, the computing system 106 receives the entity input regarding the pending interaction via the user interface. The entity input by the first entity can be an approval of the initiation of the pending interaction when the first entity approves another entity to initiate the pending interaction. The entity input by the first entity can be a disapproval of the initiation of the pending interaction when the first entity does not approve another entity to initiate the pending interaction.

At block 412, the computing system 106 controls, based on the entity input, the pending interaction. When the entity input indicates that the first entity approves to initiate the pending interaction, the interaction decision engine 118 can authorize the initiation of the pending interaction. Authorizing the initiation of the pending interaction can be one way for identification verification to confirm that the pending interaction is initiated by the first entity, or another entity approved by the first entity. When the entity input indicates that the first entity disapproves to initiate the pending interaction, the interaction decision engine 118 can cancel the pending interaction and deactivate one or more objects associated with the first entity. The pending interaction can be a pending financial transaction, and the one or more objects can be one or more financial accounts associated with the first entity.

Although the subject matter has been described in language specific to structural features or methodological acts, it is to be understood that the subject matter defined in the appended claims is not necessarily limited to the specific features or acts described above. Rather, the specific features and acts described above are disclosed only for the purpose of illustration and description and they are not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

1. A system, comprising:
a processor device; and
a non-transitory computer-readable memory including instructions that are executable by the processor device to perform operations comprising:
receiving, from an entity device associated with a first entity, a threshold value that indicates an entity preference relating to an interaction type;
intercepting a pending interaction initiated by the first entity and corresponding to the interaction type before the pending interaction is executed, the pending interaction originating from an interaction terminal configured to facilitate transfer of an electronic resource to a second entity, the pending interaction comprising an interaction value of the pending interaction, information about the first entity, and information about the second entity associated with the pending interaction;
determining, by comparing the interaction value to the threshold value, whether the interaction value is consistent with the entity preference;
providing, to the entity device, a result of a comparison between the interaction value and the threshold value; and
controlling, based on the comparison between the interaction value and the threshold value, access of the pending interaction to the electronic resource.

2. The system of claim 1, wherein the threshold value comprises a maximum value for the interaction type, wherein the maximum value for the interaction type is determinable by the first entity, and wherein the operations further comprise:
determining that the interaction value exceeds the maximum value for the interaction type; and
canceling the pending interaction in response to determining that the interaction value exceeds the maximum value for the interaction type.

3. The system of claim 1, wherein the threshold value comprises a maximum aggregate value of interactions for a predetermined period, and wherein the operations further comprise:
receiving interaction history data for the predetermined period;
determining that the interaction value associated with the pending interaction and the interaction history data for the predetermined period exceeds the maximum aggregate value of interactions; and
canceling the pending interaction in response to determining that the interaction value associated with the pending interaction and the interaction history data for the predetermined period exceed the maximum aggregate value of interactions.

4. The system of claim 1, wherein the operations further comprise:
receiving, in response to providing the result of the comparison to the entity device, an input from the entity device, the input being an updated entity preference for the pending interaction; and
controlling, based on the input from the entity device, the pending interaction substantially contemporaneously by:
authorizing the pending interaction for execution in response to determining that the input indicates that the pending interaction should proceed, and
canceling the pending interaction in response to determining that the input indicates that the pending interaction should be declined.

5. The system of claim 1, wherein the operations further comprise, after intercepting the pending interaction:
receiving a first location of the entity device;
identifying a second location where the pending interaction is initiated;
determining the first location and the second location do not match;
generating an alert message using the first location and the second location to transmit to the entity device via a user interface, the alert message comprising a request for an entity input;
receiving the entity input regarding the pending interaction via the user interface; and
controlling, based on the entity input, the pending interaction by:
authorizing the pending interaction in response to determining that the entity input indicates that the pending interaction is approved by the first entity, and
canceling the pending interaction and deactivating one or more objects associated with the first entity in response to determining that the entity input indicates that the pending interaction is initiated without approval by the first entity.

6. The system of claim 5, wherein the second entity is a website where the pending interaction is initiated, wherein the operation of identifying the second location comprises:
identifying an Internet Protocol (IP) address visiting the website;
translating the IP address into a physical address; and
identify the physical address as the second location where the pending interaction is initiated.

7. The system of claim 5, wherein the pending interaction is a pending financial transaction, wherein the electronic resource is financial information of the first entity, wherein the one or more objects are one or more financial accounts associated with the first entity.

8. A method, comprising:
receiving, by a computing device and from an entity device associated with a first entity, a threshold value that indicates an entity preference relating to an interaction type;
intercepting, by the computing device, a pending interaction initiated by the first entity and corresponding to the interaction type before the pending interaction is executed, the pending interaction originating from an interaction terminal configured to facilitate transfer of an electronic resource to a second entity, the pending interaction comprising an interaction value of the pending interaction, information about the first entity, and information about the second entity associated with the pending interaction;
determining, by the computing device and by comparing the interaction value to the threshold value, whether the interaction value is consistent with the entity preference;
providing, by the computing device and to the entity device, a result of a comparison between the interaction value and the threshold value; and
controlling, by the computing device and based on the comparison between the interaction value and the threshold value, access of the pending interaction to the electronic resource.

9. The method of claim 8, wherein the threshold value comprises a maximum value for the interaction type, wherein the maximum value for the interaction type is predetermined by the first entity, and wherein the method further comprises:
determining that the interaction value exceeds the maximum value for the interaction type; and
canceling the pending interaction in response to determining that the interaction value exceeds the maximum value for the interaction type.

10. The method of claim 8, wherein the threshold value comprises a maximum aggregate value of interactions for a predetermined period, and wherein the method further comprises:
receiving interaction history data for the predetermined period;
determining that the interaction value associated with the pending interaction and the interaction history data for the predetermined period exceeds the maximum aggregate value of interactions; and
canceling the pending interaction in response to determining that the interaction value associated with the pending interaction and the interaction history data for the predetermined period exceed the maximum aggregate value of interactions.

11. The method of claim 8, further comprising:
receiving, in response to providing the result of the comparison to the entity device, an input from the entity device, the input being an updated entity preference for the pending interaction; and
controlling, based on the input from the entity device, the pending interaction substantially contemporaneously by:
authorizing the pending interaction for execution in response to determining that the input indicates that the pending interaction should proceed, and
canceling the pending interaction in response to determining that the input indicates that the pending interaction should be declined.

12. The method of claim 8, further comprising, after intercepting the pending interaction:
receiving a first location of the entity device;
identifying a second location where the pending interaction is initiated;
determining the first location and the second location do not match;
generating an alert message using the first location and the second location to transmit to the entity device via a user interface, the alert message comprising a request for an entity input;
receiving the entity input regarding the pending interaction via the user interface; and
controlling, based on the entity input, the pending interaction by:
authorizing the pending interaction in response to determining that the entity input indicates the pending interaction is authorized, and
canceling the pending interaction and deactivating one or more objects associated with the first entity in response to determining that the entity input indicates that the pending interaction is initiated without authorization by the first entity.

13. The method of claim 12, wherein the second entity is a website where the first entity initiated the pending interaction, wherein the step of identifying the second location comprises:
identifying an Internet Protocol (IP) address visiting the website;
translating the IP address into a physical address; and
identify the physical address as the second location where the pending interaction is initiated.

14. The method of claim 12, wherein the pending interaction is a pending financial transaction, wherein the electronic resource is financial information of the first entity, wherein the one or more objects are one or more financial accounts associated with the first entity.

15. A non-transitory computer-readable medium, comprising instructions that are executable by a processor for causing the processor to perform operations comprising:
receiving, from an entity device associated with a first entity, a threshold value that indicates an entity preference relating to an interaction type;
intercepting a pending interaction initiated by the first entity and corresponding to the interaction type before the pending interaction is executed, the pending interaction originating from an interaction terminal configured to facilitate transfer of an electronic resource to a second entity, the pending interaction comprising an interaction value of the pending interaction, information about the first entity, and information about the second entity associated with the pending interaction;
determining, by comparing the interaction value to the threshold value, whether the interaction value is consistent with the entity preference;
providing, to the entity device, a result of a comparison between the interaction value and the threshold value; and
controlling, based on the comparison between the interaction value and the threshold value, access of the pending interaction to the electronic resource.

16. The non-transitory computer-readable medium of claim 15, wherein the threshold value comprises a maximum value for the interaction type, wherein the maximum value for the interaction type is determinable by the first entity, and wherein the operations further comprise:
determining that the interaction value exceeds the maximum value for the interaction type; and
canceling the pending interaction in response to determining that the interaction value exceeds the maximum value for the interaction type.

17. The non-transitory computer-readable medium of claim 15, wherein the threshold value comprises a maximum aggregate value of interactions for a predetermined period, and wherein the operations further comprise:
receiving interaction history data for the predetermined period;
determining that the interaction value associated with the pending interaction and the interaction history data for the predetermined period exceeds the maximum aggregate value of interactions; and
canceling the pending interaction in response to determining that the interaction value associated with the pending interaction and the interaction history data for the predetermined period exceed the maximum aggregate value of interactions.

18. The non-transitory computer-readable medium of claim 15, wherein the operations further comprise:
receiving, in response to providing the result of the comparison to the entity device, an input from the entity device, the input being an updated entity preference for the pending interaction; and
controlling, based on the input from the entity device, the pending interaction substantially contemporaneously by:
authorizing the pending interaction for execution in response to determining that the input indicates that the pending interaction should proceed, and
canceling the pending interaction in response to determining that the input indicates that the pending interaction should be declined.

19. The non-transitory computer-readable medium of claim 15, wherein the operations further comprise, after intercepting the pending interaction:
receiving a first location of the entity device;
identifying a second location where the pending interaction is initiated;
determining the first location and the second location do not match;
generating an alert message using the first location and the second location to transmit to the entity device via a user interface, the alert message comprising a request for an entity input;
transmitting the alert message to the entity device via a user interface;
receiving the entity input regarding the pending interaction via the user interface; and
controlling, based on the entity input, the pending interaction by:
authorizing the pending interaction in response to determining that the entity input indicates the pending interaction is authorized, and
canceling the pending interaction and deactivating one or more objects associated with the first entity in response to determining that the entity input indicates that the pending interaction is initiated without authorization by the first entity.

20. The non-transitory computer-readable medium of claim 19, wherein the pending interaction is a pending financial transaction, wherein the electronic resource is financial information of the first entity, wherein the one or more objects are one or more financial accounts associated with the first entity, wherein the second entity is a website where the first entity initiated the pending interaction, wherein the operation of identifying the second location comprises:
identifying an Internet Protocol (IP) address visiting the website;
translating the IP address into a physical address; and
identifying the physical address as the second location where the pending interaction is initiated.
